(19) United States
(12) Patent Application Publication
(10) Pub. No.: US 2025/0015681 A1
(43) Pub. Date: Jan. 9, 2025

(54) MOTOR COMPONENT PREPARED BY ELECTROLYZING COPPER, AND MOTOR

(71) Applicant: TSINGHUA UNIVERSITY, Beijing (CN)

(72) Inventor: Shanming WANG, Beijing (CN)

(21) Appl. No.: 18/729,082

(22) PCT Filed: Sep. 21, 2022
(86) PCT No.: PCT/CN2022/120084

§ 371 Date: Jul. 15, 2024

(30) Foreign Application Priority Data
Nov. 16, 2021 (CN) 202111352547.4

(51) Int. Cl. H02K 15/00; C25D 1/02; H02K 17/16

(52) U.S. Cl. CPC H02K 15/0012; C25D 1/02; H02K 17/168

(57) ABSTRACT

A motor component prepared by electrolyzing copper and a motor includes an iron core, guide bars, and end rings, wherein the guide bars are arranged in grooves on an outer circumference of the iron core, respectively, and the end rings are located at both ends of the iron core to connect the guide bars in short, the guide bars and the end rings together form an integral squirrel cage, and the guide bars and the end rings are made by a copper electrolyzing method. Thus, manufacturing processes of melting and casting refined copper are omitted, thereby lowering a requirement for energy efficiency of manufacturing process of a motor and achieving energy saving in the manufacturing process; there is no welding process, thereby avoiding welding points resulted from copper welding and improving the reliability of the motor component.

### CROSS-REFERENCE OF RELATED APPLICATIONS

The present application is a U.S. National Phase of International Application Number PCT/CN2022/120084 filed on Sep. 21, 2022, which claims priority to claims the benefit of the Chinese Patent Application No. 202111352547.4, titled “Motor component prepared by electrolytic copper and motor” filed on Nov. 16, 2021.

### FIELD OF THE INVENTION

The present disclosure relates to a motor component prepared by electrolyzing copper and a motor of the same, belonging to the technical field of motor assemblies.

### BACKGROUND OF THE INVENTION

Energy conservation and emission reduction are eternal issues of social development. Electric motors have attracted much attention as over 60% of electricity power has been consumed by them. Efficient motors become a major concern for countries, enterprises, and researchers. Countries have issued various measures to support and promote the research, development, and use of efficient motors. An asynchronous motor is the most widely used one with its distinct characteristics, and its high efficiency is of great significance.

The asynchronous motor has the advantages, such as simple structure, convenience for manufacturing, reliable operation, sturdiness and durability, and the ability of enabling self-starting without a converter, so that it has been widely used. A structure thereof is shown in FIG. 1. The motor has components including a shaft 1, an iron core 2, guide bars 3, and end rings 4. The iron core 2 is fixed on the shaft 1, and the guide bars 3 are embedded in grooves on the outer circumference of the iron core. The end rings 4 at both ends of the iron core connect the guide bars 3 in short, and the guide bars 3 and the end rings 4 form together a conductive component. As this motor component resembles a squirrel cage, it is also referred to as a squirrel cage motor component. At present, the widely used end rings and guide bars of the asynchronous motor are made of aluminum and manufactured through a casting aluminum process.

Copper has higher conductivity than aluminum, so that using copper to replace aluminum in a traditional motor component can improve the efficiency of the asynchronous motor. Currently, this is mainly implemented as a motor component enabled by copper casting or a motor component into which copper bars are inserted. However, the both still have process difficulties and drawbacks to different extents. For the motor component enabled by copper casting, manufacturing thereof is very difficult with various difficulties, including that: 1. as temperature for copper smelting and casting has to reach around 1100° C., it is difficult to select materials applicable for a mold and a die-casting machine, resulting in a short lifespan of equipment; 2. as copper has poor fluidity, high density, and low flow rate, it is difficult to implemented special groove-pattern casting and is prone to bubbles to worsen the performance; 3. copper is prone to oxidation, so that oxidation of copper due to the high temperature worsens its conductivity; 4. melting and casting both require a large amount of energy for consumption; 5. impurities is easily introduced, which reduces the purity of copper and worsens the conductivity; 6. due to the high temperature, complex process and low success rate of copper casting, consumption of iron core is high relatively. For the motor component into which copper bars are inserted and welded then, there are also some drawbacks, including that: 1. as welding is required between the end ring and the guide bars, welding points therebetween are subject to expansion and centrifugal force and thus become weak points in strength; 2. varied groove patterns require copper bars of different shapes and lengths, which are difficult to process, unless the selection of groove pattern of rotors were limited, resulting in limited performance of motors.

### SUMMARY OF THE INVENTION

In view of the above problems, the objectives of the present disclosure are to provide a motor component prepared by electrolyzing copper and a motor of the same to simplify a manufacturing process of a copper motor component and improve the efficiency of the motor.

To achieve the above objectives, the present disclosure proposes the following technical solutions. A motor component prepared by electrolyzing copper, comprising: an iron core, guide bars, and end rings, wherein the guide bars are arranged in grooves on an outer circumference of the iron core, respectively, and the end rings are located at both ends of the iron core to connect the guide bars in short, the guide bars and the end rings together form an integral squirrel cage, and the guide bars and the end rings are made by a copper electrolyzing method.

Furthermore, the copper electrolyzing method involves forming a guide bar and an end ring on the iron core through electrolysis by using refined copper as a cathode, using crude copper containing impurities as an anode, immersing the cathode and the anode in copper sulfate electrolyte, and applying a current to deposit copper on the cathode to form the guide bar and the end ring. Furthermore, the anode is arranged inside a tank, and is driven by a servo mechanism to exit along a direction of the tank while the electrolytic cathode is growing continually, so that a distance between the anode and cathode is maintained; or the anode is arranged outside the tank, near the cathode.

Furthermore, the electrolytic cathode keeps growing during electrolysis, of which a growth direction is an axial direction starting from an end ring, then a guide bar, and finally another end ring, or a radial direction that is first at bottom of a groove then up to an opening of the groove.

Furthermore, an insulation layer is provided between a guide bar and a groove of the iron core, the insulation layer is an insulation material coated on surface of the groove or an independent thin insulation material so as to limit lateral leakage current and reduce losses.

Furthermore, a high-strength material is added in the end rings, respectively, to enhance strength thereof, or fixing devices are mounted outside the end rings, respectively, to enhance strength thereof.

Furthermore, the guide bar is in a curve shape, a wave shape, or an inclined multi-slot shape in the axial direction.

The present disclosure further discloses a motor comprising a motor component prepared by electrolyzing copper as described in any one of these above, the motor component serving as a rotor or a stator of the motor.

Furthermore, a method for preparing electrolytic copper involves using refined copper having a guide bar shape and an end ring shape on the iron core as a cathode, crude copper containing impurities as an anode, immersing the cathode and the anode in copper sulfate electrolyte, and applying a current to deposit copper on the cathode.

The present disclosure has the following advantages by using of the above technical solutions. The motor component manufactured by the copper electrolyzing method and the motor according to the present disclosure get rid of traditional manufacturing processes of melting and casting refined copper, thereby greatly lowering a requirement for energy efficiency of manufacturing process of a motor, and achieving energy saving in the manufacturing process; there is no welding process like that in the manufacturing process of a motor component into which copper bars are inserted and welded then, thereby avoiding welding points resulted from copper welding and improving the reliability of the motor component; groove patterns of the motor component are not limited, thereby avoiding the problems due to poor fluidity of copper during copper casting that copper fails to well fill up a complex groove pattern and that bubbles have been resulted, and further avoiding the disadvantage that shapes of copper bars tend to single pattern, which is resulted from the process in which the copper bars are inserted; the purity of copper can be ensured, so that the conductivity of the copper motor component can be guaranteed and impurities are prevented from being introduced during copper casting; manufacturing of the motor component requires neither a high temperature like that required for copper melting, nor a corresponding high-temperature mold or device, thereby reducing equipment investment and improving equipment lifespan; groove patterns as well as the number of grooves in the motor are not limited, and a motor with a complex groove pattern, with multiple grooves can be manufactured, thereby improving a freedom of design of the motor and improving performance of the motor.

### BRIEF DESCRIPTION OF THE DRAWINGS

FIGS. 1A-IC is a schematic diagram of a structure of a motor component in the existing technology, wherein FIG. 1A is a front-view cross-sectional view of the motor component; FIG. 1B is a cross-sectional view of A-A in FIG. 1A; and FIG. 1C is a cross-sectional view of B-B in FIG. 1A;

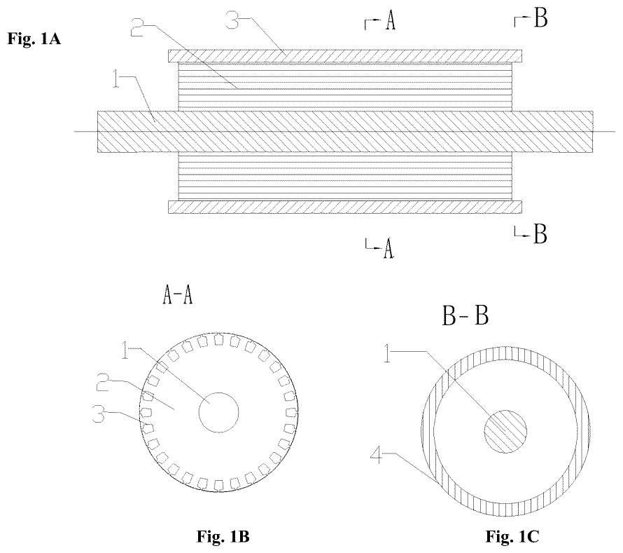

FIGS. 2A-2C is a schematic diagram of a structure of a motor component according to an embodiment of the present disclosure, wherein FIG. 2A is a front-view cross-sectional view of the motor component; FIG. 2B is a cross-sectional view of A-A in FIG. 2A; and FIG. 2C is a cross-sectional view of B-B in FIG. 2A.

### DETAILED DESCRIPTION OF THE EMBODIMENTS

For better understanding of the technical direction of the present disclosure by those skilled in the art, the present disclosure is described in detailed by means of specific embodiments. However, it should be understood that the specific embodiments are provided only for a better understanding of the present disclosure, and should not be considered as limitations to the present disclosure. In the description of the present disclosure, it should be understood that terms that are used are only for the purpose of description, rather than indicating or implying relative importance.

The present disclosure relates to a motor component prepared by electrolyzing copper and a motor of the same, in which a guide bar and an end ring are prepared by a copper electrolyzing method so that energy required for copper melting during copper casting processing can be avoided. Two energy consumption processes, i.e., refining from crude copper to refined copper, and melting and casting of refined copper, are integrated into one processing of refining from crude copper to refined copper, so that a requirement for energy efficiency of manufacturing process of a motor can be greatly lowered, achieving energy saving in the manufacturing process.

### Embodiment 1

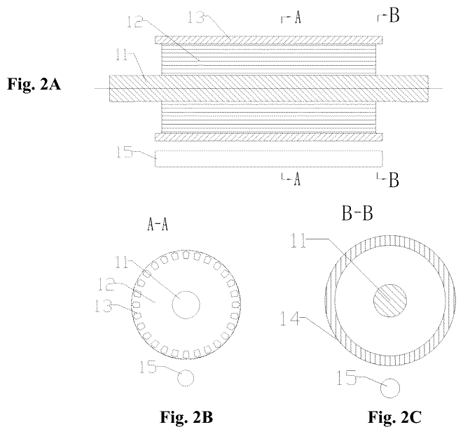

The present embodiment discloses a motor component prepared by electrolyzing copper, as shown in FIG. 2, comprising: a shaft 11, an iron core 12, guide bars 13, and end rings 14. The guide bars 13 are arranged in grooves on an outer circumference of the iron core 12, and the end rings 14 are located at both ends of the iron core 12 and connect the guide bars in short. The guide bars 13 and the end rings 14 together form a conductive component, and are made by a copper electrolyzing method.

Before electrolysis of copper, there were no guide bars 13 or end rings 14. A refined copper initial cathode can be provided inside a groove or at a position of an end ring. The initial cathode may be a small piece of refined copper, a small part of the end ring, or a small part of a guide bar. In the copper electrolyzing method, the initial cathode, i.e., a refined copper cathode, is used as a base, and crude copper 15 containing impurities is used as an anode. Cathodes continuously grows under the action of electrolysis, so that, finally, guide bars 13 are formed in the iron core 12 as well as end rings 14 connecting with the guide bars 13 as a whole. The guide bars 13 fill up grooves on the iron core 12 and have corresponding shapes. The end rings 14 are required to be shaped by a mold of specialized pattern to form a desired shape. A shape of the crude copper 15 may be configured as desire. In the embodiment, preferably, the crude copper 15 is made into a thin-rod shape and extends into an electrolysis tank. The cathodes and the anodes are immersed in copper sulfate electrolyte, and are applied with a current to allow copper to deposit on the cathodes. The anodes are arranged inside the tank, and are driven by a servo mechanism to exit along a direction of the tank while the electrolytic cathodes are growing continually, so that a distance between the anodes and the cathodes is maintained; alternatively, the anodes are arranged outside the tank, near the cathode. In the embodiment, a concentration of the copper sulfate electrolyte may be between 90 g/L and 150 g/L, a reaction temperature may be between 50° C. and 65° C., intensity of the current may be between 60 A/dm² and 75 A/dm², and a electrolysis duration can be determined as desire, which is not specially limited here.

During the electrolysis, the amplitude of the electrolysis current and the concentration of the electrolyte are configured according to production task, production time, and quality of copper to be electrolyzed. The temperature is configured according to electrolysis requirements.

The electrolytic cathodes keep growing during the electrolysis, and a growth direction thereof is an axial direction starting from an end ring 14, then the guide bars 13, and finally another end ring 14, or a radial direction that is first at bottom of the grooves then up to opening of the grooves.

An insulation layer is provided between a guide bar 13 and a groove of the iron core 12. The insulation layer is an insulation material coated on the surface of the groove or an independent thin insulation material, so as to limit lateral leakage current, reduce losses, and further improve the efficiency of a motor. The insulation material in the embodiment may be insulation film, insulation paper, insulation paint, etc.

The guide bars 13 are arranged inside the grooves of the iron core 12, respectively, fixing of which is relatively stable. However, the end rings 14 are suspended circular rings that bear centrifugal force while a rotor is rotating. In order to improve reliable fixing of the end rings 14, a high-strength material is added in the end rings 14, respectively, to enhance the strength thereof, or fixing devices are mounted outside of the end rings 14, respectively, to enhance the strength thereof. The high strength material includes, but is not limited to, a high-strength metal ring.

An existing guide bar 13 is generally in a straight-line shape. In the embodiment, a guide bar 13 formed by electrolyzing copper can have any shape in the axial direction, such as a curve shape, a wave shape, or an inclined multi-slot shape. Its shape depends on a related mold, which can greatly reduce the cogging effect, improve torque stability, and reduce vibration.

### Embodiment 2

Based on the same invention concept, the present embodiment discloses a motor, comprising a motor component prepared by electrolyzing copper as described in any of those above. The motor component can be used as a rotor or a stator. If the motor component is used as a stator, the motor further comprises a related rotor, and if the motor component is used as a rotor, the motor further comprises a related stator.

In the embodiment, preferably, the motor is an asynchronous motor, and the motor component serves as a rotor of the motor, thereby achieving an efficient motor. However, in the embodiment, the motor can also be a solid rotor asynchronous motor, or a composite rotor asynchronous motor, etc.

Before electrolysis of copper, there were no guide bars 13 or end rings 14. A refined copper initial cathode can be provided inside a groove or at a position of an end ring. The initial cathode may be a small piece of refined copper, a small part of the end ring, or a small part of a guide bar. In the copper electrolyzing method, the initial cathode, i.e., a refined copper cathode, is used as a base, and crude copper 15 containing impurities is used as an anode. Cathodes continuously grow under the action of electrolysis, so that, finally, guide bars 13 are formed in the iron core 12 as well as end rings 14 connecting with the guide bars 13 as a whole. The guide bars 13 fill up grooves on the iron core 12 and have corresponding shapes. The end rings 14 are required to be shaped by a mold of specialized pattern to form a desired shape. A shape of the crude copper 15 may be configured as desire. In the embodiment, preferably, the crude copper 15 is made into a thin-rod shape and extends into an electrolytic tank. The cathodes and the anodes are immersed in copper sulfate electrolyte, and are applied with a current to allow copper to deposit on the cathodes. The anodes are arranged inside the tank, and are driven by a servo mechanism to exit along a direction of the tank while the electrolytic cathodes are growing continually, so that a distance between the anodes and cathodes is maintained; alternatively, the anodes are arranged outside the tank, near the cathodes.

Finally, it should be noted that the above embodiments are only intent to illustrate the technical solution of the present disclosure, not to construct limitation thereto. Although the present disclosure has been described in detail with reference to the above embodiments, it should be understand by those of ordinary skill in the art that it is still possible to perform modifications or equivalent replacements on the specific embodiments of the present disclosure. Any modification or equivalent replacement that does not deviate from the spirit and scope of the present disclosure should be fall within the scope of protection of the claims of the present disclosure. The above content is only the specific implementations of the present application, but the scope of protection of the application is not limited thereto. Within the disclosed technical scope of the application, anyone familiar with the technical field can readily think of changes or replacements, which should fall into the scope of protection of the application. Therefore, the scope of protection of the application shall be based on the scope of protection of the claims.

1. A motor component prepared by electrolyzing copper, comprising: an iron core, guide bars, and end rings, wherein the guide bars are arranged in grooves on an outer circumference of the iron core, respectively, and the end rings are located at both ends of the iron core to connect the guide bars in short, the guide bars and the end rings together form an integral squirrel cage, and the guide bars and the end rings are made by a copper electrolyzing method.

2. The motor component prepared by electrolyzing copper according to claim 1, wherein the copper electrolyzing method involves forming a guide bar and an end ring on the iron core through electrolysis by using refined copper as a cathode, using crude copper containing impurities as an anode, immersing the cathode and the anode in copper sulfate electrolyte, and applying a current to deposit copper on the cathode to form the guide bar and the end ring.

3. The motor component prepared by electrolyzing copper according to claim 2, wherein the anode is arranged inside a tank, and is driven by a servo mechanism to exit along a direction of the tank while the electrolytic cathode is growing continually, so that a distance between the anode and cathode is maintained; or the anode is arranged outside the tank, near the cathode.

4. The motor component prepared by electrolyzing copper according to claim 2, wherein the electrolytic cathode keeps growing during electrolysis, of which a growth direction is an axial direction starting from an end ring, then a guide bar, and finally another end ring, or a radial direction that is first at bottom of a groove then up to an opening of the groove.

5. The motor component prepared by electrolyzing copper according to claim 1, wherein an insulation layer is provided between a guide bar and a groove of the iron core, the insulation layer is an insulation material coated on surface of the groove or an independent thin insulation material so as to limit lateral leakage current and reduce losses.

6. The motor component prepared by electrolyzing copper according to claim 1, wherein a high-strength material is added in the end rings, respectively, to enhance strength thereof, or fixing devices are mounted outside the end rings, respectively, to enhance strength thereof.

7. The motor component prepared by electrolyzing copper according to claim 1, wherein the guide bars are in a curve shape, a wave shape, or an inclined multi-slot shape in the axial direction.

8. A motor, comprising a motor component prepared by electrolyzing copper according to claim 1, wherein the motor component serves as a rotor or a stator of the motor.

9. The motor according to claim 8, wherein the copper electrolyzing method involves forming a guide bar and an end ring on the iron core through electrolysis by using refined copper as a cathode, using crude copper containing impurities as an anode, immersing the cathode and the anode in copper sulfate electrolyte, and applying a current to deposit copper on the cathode to form the guide bar and the end ring.

10. The motor component prepared by electrolyzing copper according to claim 2, wherein a high-strength material is added in the end rings, respectively, to enhance strength thereof, or fixing devices are mounted outside the end rings, respectively, to enhance strength thereof.

11. The motor component prepared by electrolyzing copper according to claim 3, wherein a high-strength material is added in the end rings, respectively, to enhance strength thereof, or fixing devices are mounted outside the end rings, respectively, to enhance strength thereof.

12. The motor component prepared by electrolyzing copper according to claim 4, wherein a high-strength material is added in the end rings, respectively, to enhance strength thereof, or fixing devices are mounted outside the end rings, respectively, to enhance strength thereof.

13. The motor component prepared by electrolyzing copper according to claim 5, wherein a high-strength material is added in the end rings, respectively, to enhance strength thereof, or fixing devices are mounted outside the end rings, respectively, to enhance strength thereof.

14. The motor component prepared by electrolyzing copper according to claim 2, wherein the guide bars are in a curve shape, a wave shape, or an inclined multi-slot shape in the axial direction.

15. The motor component prepared by electrolyzing copper according to claim 3, wherein the guide bars are in a curve shape, a wave shape, or an inclined multi-slot shape in the axial direction.

16. The motor component prepared by electrolyzing copper according to claim 4, wherein the guide bars are in a curve shape, a wave shape, or an inclined multi-slot shape in the axial direction.

17. The motor component prepared by electrolyzing copper according to claim 5, wherein the guide bars are in a curve shape, a wave shape, or an inclined multi-slot shape in the axial direction.
